(19) United States
(12) Patent Application Publication
(10) Pub. No.: US 2008/0035359 A1
(43) Pub. Date: Feb. 14, 2008

(54) Cultivator Tine for a Soil Cultivation Tine Support Frame

(76) Inventors: Dave Hundeby, Saskatoon (CA); Cyril Thirouin, Briis sous Forges (FR)

Correspondence Address: YOUNG & THOMPSON, 745 SOUTH 23RD STREET, 2ND FLOOR, ARLINGTON, VA, 22202, US

(21) Appl. No.: 11/631,963

(22) PCT Filed: Jul. 1, 2005
(86) PCT No.: PCT/FR05/01681

§ 371 Date: Mar. 9, 2007

(30) Foreign Application Priority Data
Jul. 16, 2004 (FR) 0407920

(51) Int. Cl. A01B 23/02

(52) U.S. Cl. 172/713

(57) ABSTRACT

A cultivator tine (1) for a soil cultivation tine support frame of the type that includes at least one bearing leg (2) and a removable wear part (3) which works the soil. The tine is characterised in that the system for fixing the removable working part (3) to the leg (2) is mainly formed by a housing (4) which is provided in the leg close to the free end thereof, in order to receive at least one member for blocking a connecting element (6), generally of the pin or cleat type, between the wear part (3) and the leg (2), such as to isolate the gripping part of the blocking member (5) and prevent the premature abrasive wear of same. The housing (4) is larger than the blocking member (5) such that the member (5) can always be accessed when the working wear part (3) is being replaced or adjusted.

This invention relates to a cultivator tine for a soil-cultivating tine mount frame of the type composed of a bearing leg and a stationary wearing part cultivating the soil.

These tines are generally installed on a frame in the form of one or more rows of tines for covering a cultivating width each time. Each tine has a working part that is generally bolted to the leg for purposes of facilitating its dismounting. In fact, when the working part is worn, it must be possible to replace it. Moreover, such a manner of attachment allows adjustment of the position of the working part allowing, for example, movement of the working part toward the soil as the part becomes worn.

For a long time, it has been noted that the nut and/or the bolt wears and deforms upon contact with the soil or rocks located in the soil as the frame advances, as the U.S. Pat. No. 5,007,484 illustrates. For this reason, it is difficult or impossible to remove the nut from the bolt with suitable tools, such as a hand wrench or impact wrench. It is often necessary to mechanically cut the bolt with a chisel, hand saw, power saw, or a torch. The results are a loss of time and possibly the need to replace the leg and/or the working part for the case in which it would have been damaged by the mechanical torque. Finally, the bolt and/or attachment in general can no longer be re-used.

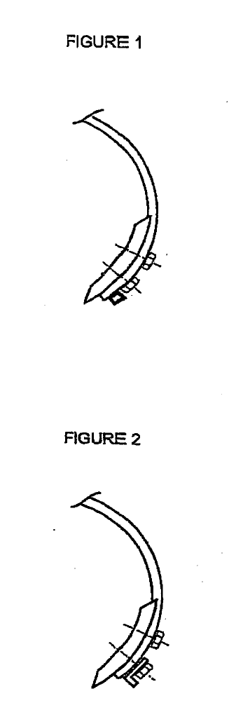

To remedy these drawbacks, various solutions have been envisioned, as especially FIGS. 1 and 2 illustrate. Thus, connecting a welded pin designed to form a screen that protects the bolt as described especially by patent EP-0,704,146 in the vicinity of the free end of the leg has already been suggested. This approach has the problem of adding material to the base of the leg. This results in a lack of clearance between the bottom of the leg and the lower portion of the wearing part. Thus, when the wearing part begins to wear, the bottom of the leg then in turn risks wearing. Another result of this addition of material is the risk of adversely affecting the good penetration of the tine, producing a drag effect.

A second approach in accordance with the one shown in FIG. 2 consists in connecting a folded plate upstream from the leg taken in the direction of advance of the frame. The problems noted with the pin are likewise present in this type of approach.

A third approach is described in U.S. Pat. No. 4,932,478. This patent describes a leg provided with a protective part and a stationary wearing part integral with the leg at the level of its free end. The wearing part is made integral with the leg by an axis extending transversely to the advance axis of the leg. This axis periodically crosses the leg before penetrating into the housings of the wearing part. The dimensions of these housings are for the most part greater than the axis to allow a nut to be accommodated. This oversizing of the housings arranged in the wearing part makes it necessary to reinforce the wearing part in order not to undermine its mechanical strength. This results in added cost at the time of production. Moreover, the presence of these housings weakens the wearing part that is already greatly loaded as the tine is working. This approach is thus unsatisfactory.

One objective of this invention is thus to propose a cultivator tine for a soil-cultivating tine mount frame, of which the attachment means between the wearing part, working part and a leg are not subjected to wear and to deformation, thus allowing easy dismounting from the working wearing part for the purpose of replacement or adjustment of said part.

Another objective of this invention is to suggest a cultivator tine whose design for attachment of the stationary working part to the leg facilitates dismounting of the working part without adversely affecting the mechanical strength of the leg or the working part.

For this reason, the object of the invention is a cultivator tine for a soil-cultivating tine mount frame of the type comprising at least one bearing leg and a stationary wearing part that cultivates the soil, characterized in that the attachment of the stationary working part to the leg is formed mainly by a housing arranged in the leg, in the vicinity of the free end of the leg, to receive at least one stopping element of a connecting element, generally of the bolt or key type between the wearing part and the leg, to isolate the holding part of said stopping element to prevent its premature wear by abrasion, the dimensions of said housing being greater than those of the stopping element to allow permanent access to said element during operations of replacement or adjustment of the working wearing part.

Due to the arrangement of a larger housing in the leg and not in the highly loaded wearing or working part, the mechanical strength of the working part is not reduced.

According to one preferred embodiment of the invention, the housing of the stopping element arranged in the leg is obtained without removing material, by forging, preferably hot forging, for making the component matter of the leg more dense in this zone.

Due to the technology adopted for implementing the housing of the stopping element, the mechanical strength of the leg is not reduced in any case.

The invention will be better understood from reading the following description of embodiments, with reference to the accompanying drawings, in which:

FIGS. 1 and 2 show the prior art;

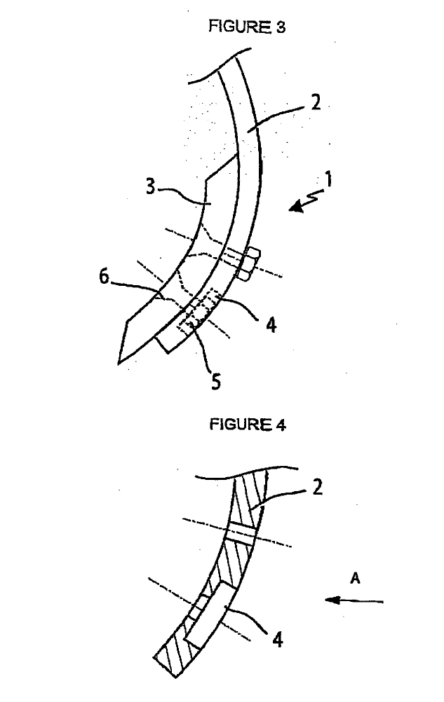

FIG. 3 shows a partial side view of one tine of the cultivator according to the invention;

FIG. 4 shows a partial side view of the leg;

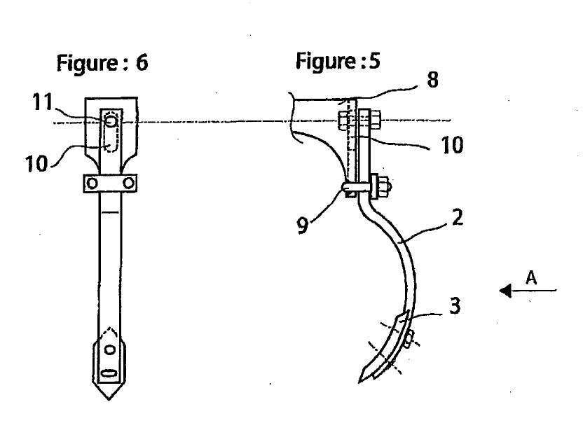

FIG. 5 shows a side view of a tine according to the invention with its position adjustment device;

FIG. 6 shows a view following A from FIG. 5;

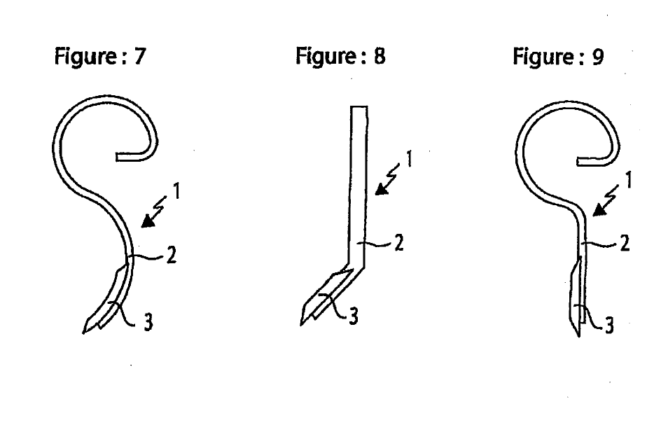

FIGS. 7 to 9 illustrate other embodiments of the tines of the cultivator according to the invention, and

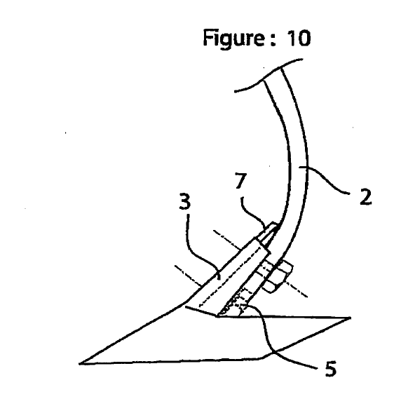

FIG. 10 shows a partial schematic view of another manner of the connection between the leg and the wearing part.

As mentioned above, the cultivator tine 1, the object of the invention, is designed to be positioned on a soil-cultivating tine mount frame. This cultivator tine 1 is composed of a leg 2 that can be connected to the frame generally via a safety device called a non-stop. This leg 2 bears a stationary wearing part 3 cultivating the soil. As its name indicates, this part 3 must be regularly changed. It is for this reason that this part 3 is attached in a stationary manner to the leg 2. Leg 2 and wearing part 3 can assume a large number of forms, as shown in FIGS. 7 to 9, in which a flexible S tine, a rigid tine and a flexible straight tine respectively have been shown. The following description will be applied more especially to a C tine.

The working or wearing part 3 is connected to the front part or leading edge of the leg 2 extending to the vicinity of the free end of the leg 2. It thus is used to cover the front part of the leg and protect it when the tine assembly is cultivating the soil.

The attachment of the stationary working part 3 to the leg is composed mainly of a housing 4 that is arranged in the vicinity of the free end of the leg 2. This housing 4 makes it possible to accommodate at least one stopping means 5 of a connecting element 6 between the wearing part 3 and leg 2. This housing 4 thus makes it possible to isolate the holding part of said stopping element 5 in order to prevent its premature wear by abrasion. The dimensions of this housing 4 are greater than those of the stopping element 5 to allow permanent access to the element 5 during operations of replacement or adjustment of the working wearing part 3.

Generally, the working wearing parts 3 and the leg 2 are interconnected by bolting. In this case, the screw comprises the connecting element 6 between the part 3 and the leg 2, whereas the bolt comprises the stopping element 5. One equivalent embodiment can be obtained by using a key that comprises the connection element 6 and a pin comprising the stopping element 5 of the key. In general, the wearing part 3 thus includes a milled traversing housing for accommodating a screw whose end opposite to the screw head is accommodated in the housing that is arranged for this purpose in the leg 2 to hold a nut 5 there for mounting. The housings arranged in the wearing part 3 and in the leg respectively delineate a passage for the connecting element 6 extending from front to back of said tine in a plane that is essentially parallel to the axis of tine advance. In the case of a nut, it is essential that the dimensions of the housing 4 be larger than those of the stopping element 5 to allow ordinary tools to access the connecting parts of the nut, in this case around the periphery of the latter, and to allow it to be unscrewed.

Various connecting configurations can be envisioned between the wearing part 3 and the leg 2. Thus, as illustrated by FIG. 3 and the following figures, the working wearing part 3 can be coupled directly to the leg 2 by bolting.

In FIG. 10, the wearing part 3 is coupled to the leg 2 by an intermediate part 7 that is bolted to the leg 2 and on which the wearing part 3 is engaged by sliding. The bolt connecting the part 7 and the leg 2 is equipped with a nut mounted in a housing of the leg in a manner similar to that mentioned above in the case of a direct connection between the wearing part 3 and the leg 2.

This housing 4 of the stopping element 5 arranged in the leg 2 is preferably obtained without removing material by forging, preferably hot forging, to make the component material of the leg more dense in this zone. The housing can be round, oblong, hexagonal, rectangular or square. According to the type of attachment adopted, this housing can be arranged on the back of the leg or on the lateral part or parts of the latter. Such a housing can be sized to accommodate one or more stopping elements 5. By virtue of this design, no material is added at the level of the free end of the leg such that the effect of dragging observed to date in previous designs is eliminated. In the same way, no wear of the leg is noted.

To complete the attachment of the wearing part 3 to the leg, in addition to the first screw 6/nut 5 assembly positioned in the vicinity of the free end of the leg 2, a second screw/nut assembly can be provided. The presence of a second screw makes it possible to keep the wearing part secure (or the “cone” supporting this wearing part). In the presence of repeated impacts (stones), thus any possibility of lateral pivoting of the wearing part or of the cone supporting this wearing part is avoided. It is not necessary to reproduce a bolt insertion housing in the leg for this second assembly due to positioning of the projecting nut at a higher level, making damage to the nut by a surface stone of low probability. Moreover, if the forces applied to the wearing part and its attachment elements are analyzed when working, the bolt from the top is under tension, whereas the bolt from the bottom is under compression. Being under tension, there is no advantage to reducing the thickness of the leg for this second bolt.

The above-described cultivator tines, as already mentioned, are installed generally on a frame that is moved forward using a tractor engine. The wheels of this tractor vehicle or the wheels allowing control of the working depth of agricultural implements have a tendency to leave impressions on the ground that can be removed by the passage of the cultivator tine, the marking or tamping being caused by the compaction of the wheels. This is because a soil with differences of height is not favorable to good sowing of the crop. In fact, variation of the seed planting depths, different soil texture and water accumulation are found in places. All of these elements cause poor germination, differences of the vegetation stage of the crop resulting in uneven maturity and yield losses. To correct the adverse effects of the passage of the wheels or tracks of the tractors or wheels that allow the implement depth to be controlled, it is necessary to be able to individually control the height of the tine or tines located in the axis of wheel passage. The localized lowering to the level of the tamped part of the soil makes it possible to loosen the initial soil volume. Thus, the terrain, after passage of the implement, is perfectly leveled and uniform. To date, this adjustment has been carried out by adding a block, either by adjustment by the bolt of the tine on its support or of the support on the frame. The resulting drawbacks are the absence of continuous adjustment, since this adjustment depends either on distances between the bolts or the thickness of the block. Thus, it is sometimes necessary, depending on the parameters of the soil (texture, moisture content, presence of harvest residues) to modify to about one millimeter the positioning of one tine or group of tines in height. In the case of using a blocks or bolts, this requires careful dismantling and the necessity of having within reach a block of the right thickness or a bolt passage corresponding to the desired positioning of the implement.

The tine that is the object of the invention remedies this drawback by the design of its linkage to the frame that allows continuous adjustment of the biting of the tine to about one millimeter. The tine 1 of the cultivator thus has one end of the leg 2 connected to the frame by a connecting part 8 with the shape of a plate bearing, on the one hand, a flange 9 that can be tightened, through which the end of the leg 2 is engaged, and, on the other hand, an aperture 10 for passage of an additional tightening means, such as a bolt 11 borne by the leg 2 and allowing adjustment of the biting position of the leg 2 relative to the connecting part 8. Thus, in a first step, the end of the leg is inserted through the flange 9. This end of the leg is provided with a hole through which a bolt is inserted that attaches the connecting part 8 to the leg 2. Once the position of the leg has been adjusted vertically, due to the presence of the aperture 10 in the connecting part 8 that allows sliding motion of the leg along the part 8, the nut of the bolt is tightened and the flange 9 is likewise tightened via an additional nut. Thus, the leg 2 and the working wearing part are perfectly stopped in a position corresponding to that desired by the user.

1. Cultivator tine (1) for a soil-cultivating tine mount frame of the type composed of at least one bearing leg (2) and a stationary wearing part (3) cultivating the soil,
characterized in that
the attachment of the stationary working part (3) to the leg (2) is formed mainly by a housing (4) arranged in the leg, in the vicinity of the free end of the leg (2), to receive at least one stopping element of a connecting element (6), generally of the bolt or key type between the wearing part (3) and the leg (2), to isolate the holding part of said stopping element (5) to prevent its premature wear by abrasion, the dimensions of said housing (4) being greater than those of the stopping element (5) to allow permanent access to said element (5) especially during operations of replacement or adjustment of the working wearing part (3).

2. Cultivator tine (1) according to claim 1, wherein the housing (4) of the stopping element (5) arranged in the leg (2) is obtained, without removing material, by forging, preferably hot forging, for making the component matter of the leg (2) more dense in this zone.

3. Cultivator tine (1) according to claim 1, wherein the working wearing part (3) is coupled directly to the leg (2) by bolting.

4. Cultivator tine (1) according to claim 1, wherein the wearing part (3) is coupled to the leg (2) by an intermediate part (7) that is bolted to the leg (2) and on which the wearing part (3) is engaged by sliding.

5. Cultivator tine (1) according to claim 1, wherein one end of the leg (2) is connected to the frame by a connecting part (8) with the shape of a plate that bears, on the one hand, a flange (9) that can be tightened, through which the end of the leg (2) is engaged, and, on the other hand, an aperture (10) for passage of an additional tightening means, such as a bolt (11) borne by the leg (2) and allowing adjustment of the biting position of the leg (2) relative to the connecting part.

6. Cultivator tine (1) according to claim 2, wherein the working wearing part (3) is coupled directly to the leg (2) by bolting.

7. Cultivator tine (1) according to claim 2, wherein the wearing part (3) is coupled to the leg (2) by an intermediate part (7) that is bolted to the leg (2) and on which the wearing part (3) is engaged by sliding.

8. Cultivator tine (1) according to claim 2, wherein one end of the leg (2) is connected to the frame by a connecting part (8) with the shape of a plate that bears, on the one hand, a flange (9) that can be tightened, through which the end of the leg (2) is engaged, and, on the other hand, an aperture (10) for passage of an additional tightening means, such as a bolt (11) borne by the leg (2) and allowing adjustment of the biting position of the leg (2) relative to the connecting part.

9. Cultivator tine (1) according to claim 3, wherein one end of the leg (2) is connected to the frame by a connecting part (8) with the shape of a plate that bears, on the one hand, a flange (9) that can be tightened, through which the end of the leg (2) is engaged, and, on the other hand, an aperture (10) for passage of an additional tightening means, such as a bolt (11) borne by the leg (2) and allowing adjustment of the biting position of the leg (2) relative to the connecting part.

10. Cultivator tine (1) according to claim 4, wherein one end of the leg (2) is connected to the frame by a connecting part (8) with the shape of a plate that bears, on the one hand, a flange (9) that can be tightened, through which the end of the leg (2) is engaged, and, on the other hand, an aperture (10) for passage of an additional tightening means, such as a bolt (11) borne by the leg (2) and allowing adjustment of the biting position of the leg (2) relative to the connecting part.
